(19) United States
(12) Patent Application Publication
(10) Pub. No.: US 2019/0259066 A1
(43) Pub. Date: Aug. 22, 2019

(54) COMMUNICATION DEVICE, SERVER DEVICE, RECORDING MEDIUM, AND CONTROL METHOD

(71) Applicant: SONY CORPORATION, TOKYO (JP)

(72) Inventor: MASAMICHI ASUKAI, KANAGAWA (JP)

(21) Appl. No.: 16/329,507

(22) PCT Filed: Aug. 4, 2017
(86) PCT No.: PCT/JP2017/028501

§ 371 Date: Feb. 28, 2019

(30) Foreign Application Priority Data
Nov. 9, 2016 (JP) 2016-218740

(51) Int. Cl. G06Q 30/02; H04W 4/21; G06Q 50/00

(52) U.S. Cl. CPC G06Q 30/0261; H04W 4/21; G06Q 30/0267; G06Q 30/0269; G06Q 50/01; G06Q 30/0255

(57) ABSTRACT

[Object] To provide a communication device, a server device, a recording medium, and a control method, which are capable of transmitting request information to surrounding users at appropriate timing depending on the atmosphere of surrounding users. [Solution] A communication device attachable to a target object, the communication device including: a detection unit configured to detect contact or proximity of a surrounding user; a communication unit configured to be capable of transmitting information to a surrounding terminal device; and a control unit configured to perform control so that request information to be transmitted to the surrounding terminal device depending on an atmosphere of the surrounding user recognized on the basis of detection data detected by the detection unit is transmitted through the communication unit.

### TECHNICAL FIELD

The present disclosure relates to a communication device, a server device, a recording medium, and a control method.

### BACKGROUND ART

In events of regional promotion, various public relations (PR), or the like, digital signage for attracting customers is exhibited or local mascot characters (e.g., Yuru-chara) are used.

Here, techniques of acquiring information relating to people who attracted are described. In one example, Patent Literature 1 below discloses a technique of calculating a person's interest in a measurement target and estimating an attribute of the measurement target in which the person is interested, on the basis of attributes of people, things, places, or the like, detection of a position of a person by a monitoring camera or the like, and detection of a face or facial expression.

Further, Patent Literature 2 below discloses a technique of learning an algorithm of action determination by increasing the consideration point of the action at a satisfactory time on the basis of the user's reaction and emotion to the action of the robot.

Further, Patent Literature 3 below discloses a technique of measuring the position and staying time at which a person stays by laser ranging and visualizing the popularity degree of the exhibited work.

Further, Patent Literature 4 below discloses a technique of measuring the staying time and the number of people near a ranging target by the camera and calculating the degree of attention for the target.

Further, Patent Literature 5 below discloses a technique of counting the number of viewers who are turning their line of sight to the display video by the camera.

### CITATION LIST

### Patent Literature

Patent Literature 1: JP 2010-20718A

Patent Literature 2: JP 2016-012340A

Patent Literature 3: JP 2008-076234A

Patent Literature 4: JP H10-048008A

Patent Literature 5: JP 2011-146048A

### DISCLOSURE OF INVENTION

### Technical Problem

However, although it is possible to attract people by using articles of exhibition or to measure interests of people who attracted, the excitement of people who attracted is subject to change. Thus, even if coupons (electronic coupons) are distributed to encourage purchase of goods or invitation for participation in the organizer's social networking service (SNS) is made, there remains a problem of failing to achieve satisfactory effect unless the timing is met.

In view of this, the present disclosure provides a communication device, a server device, a recording medium, and a control method, which are capable of transmitting request information to surrounding users at appropriate timing depending on the atmosphere of surrounding users.

### Solution to Problem

According to the present disclosure, there is provided a communication device attachable to a target object, the communication device including: a detection unit configured to detect contact or proximity of a surrounding user; a communication unit configured to be capable of transmitting information to a surrounding terminal device; and a control unit configured to perform control so that request information to be transmitted to the surrounding terminal device depending on an atmosphere of the surrounding user recognized on the basis of detection data detected by the detection unit is transmitted through the communication unit.

According to the present disclosure, there is provided a server device including: a communication unit configured to receive information from a communication device that is attached to a target object and capable of transmitting request information to a surrounding terminal device depending on an atmosphere estimated via contact or proximity of a surrounding user of the target object; and a control unit configured to generate visualization information on the basis of at least one piece of information among issuance date and time, issuance position information indicating a position of the communication device upon issuance, an ID of the target object, a degree of excitement of the surrounding user, or content information included in the request information, which is received by the communication unit, when the communication device transmits the request information to the surrounding terminal device.

According to the present disclosure, there is provided a recording medium having a program recorded thereon, the program causing a computer to function as: a detection unit configured to detect contact or proximity of a surrounding user; a communication unit configured to be capable of transmitting information to a surrounding terminal device; and a control unit configured to perform control so that request information to be transmitted to the surrounding terminal device depending on an atmosphere of the surrounding user recognized on the basis of detection data detected by the detection unit is transmitted through the communication unit.

According to the present disclosure, there is provided a control method including: receiving, by a processor, information through a communication unit from a communication device that is attached to a target object and capable of transmitting request information to a surrounding terminal device depending on an atmosphere estimated via contact or proximity of a surrounding user of the target object; and generating, by the processor, visualization information on the basis of at least one piece of information among issuance date and time, issuance position information indicating a position of the communication device upon issuance, an ID of the target object, a degree of excitement of the surrounding user, or content information included in the request information, which is received by the communication unit, when the communication device transmits the request information to the surrounding terminal device.

### Advantageous Effects of Invention

According to the present disclosure as described above, it is possible to transmit request information to surrounding users at appropriate timing depending on the atmosphere of surrounding users.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram illustrated to describe an overview of an information processing system according to an embodiment of the present disclosure.

FIG. 2 is a diagram illustrating an overall configuration of an information processing system according to a first embodiment.

FIG. 3 is a flowchart illustrating operation processing according to the first embodiment.

FIG. 4 is a flowchart illustrating operation processing according to a first modification of the first embodiment.

FIG. 5 is a diagram illustrating an overall configuration of an information processing system according to a second modification of the first embodiment

FIG. 6 is a flowchart illustrating operation processing according to the second modification of the first embodiment.

FIG. 7 is a diagram illustrating a specific example of visualization of promotional effect according to the second modification of the first embodiment.

FIG. 8 is a diagram illustrating a specific example of visualization of promotional effect according to the second modification of the first embodiment.

FIG. 9 is a diagram illustrating a specific example of visualization of promotional effect according to the second modification of the first embodiment.

FIG. 10 is a diagram illustrating a specific example of visualization of promotional effect according to the second modification of the first embodiment.

FIG. 11 is a diagram illustrating a specific example of visualization of promotional effect according to the second modification of the first embodiment.

FIG. 12 is a diagram illustrated to describe an overview of an information processing system according to a second embodiment.

FIG. 13 is a diagram illustrating an overall configuration of an information processing system according to the second embodiment.

FIG. 14 is a flowchart illustrating operation processing according to the second embodiment.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, the description will be made in the following order.

1. Overview of information processing system according to embodiment of present disclosure
2. First embodiment

### 2-1. Configuration

2-2. Operation processing
2-3. First modification
2-4. Second modification
3. Second embodiment

### 3-1. Configuration

3-2. Operation processing
4. Concluding remarks

### 1. Overview of Information Processing System According to Embodiment of Present Disclosure

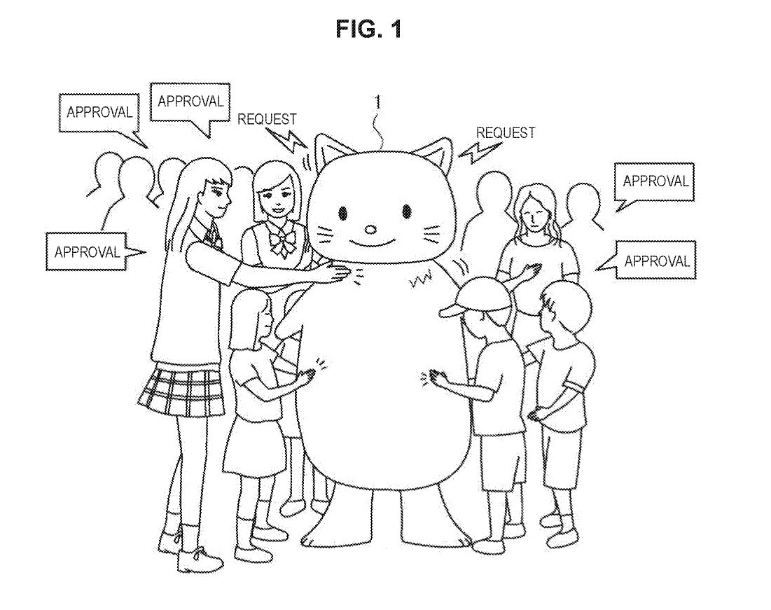

FIG. 1 is a diagram illustrated to describe an overview of an information processing system according to an embodiment of the present disclosure. As illustrated in FIG. 1, in the information processing system according to the present embodiment, an information processing apparatus 1 (communication device) attached to a target object such as a costumed character is capable of detecting contact or proximity of surrounding users with the target object and detecting excitement of the surrounding users.

### (Background)

As described above, in related art, no information presentation is performed in consideration of excitement of people upon attracting people using signage exhibition, characters, or the like. Thus, even if coupons (electronic coupons) are distributed to encourage purchase of goods or invitation for participation in the organizer's SNS group (social media group) is made, there remains a problem of failing to achieve satisfactory effect unless the timing is met.

Thus, in the information processing system according to an embodiment of the present disclosure, upon detecting the excitement of surrounding users, the request information that request the user to perform a predetermined action such as distribution of discount coupons (encouraging purchase) or invitation to the event organizer's SNS (encouraging approval/registration) is controlled to be broadcast. People are feeling well when they are excited (when their interest is increasing) and the possibility of responding to the request is increased, so approval to SNS, use of coupons, or the like is performed by more people, thereby conducting promotion effectively.

The information processing system according to the present disclosure described above is described in detail below by way of a plurality of embodiments.

### 2. First Embodiment

### <2-1. Configuration>

A case is first described, as a first embodiment, where an information processing apparatus 1-1 is attached to a costumed character or the like as described with reference to FIG. 1 and a request for participation (example of request information) in the organizer's SNS group is transmitted to communication terminals (terminal devices such as smartphones, smartbands, smartwatches, eyeglass-type head mounted displays (HMDs), music players, or game machines) of surrounding people when the surrounding people are excited.

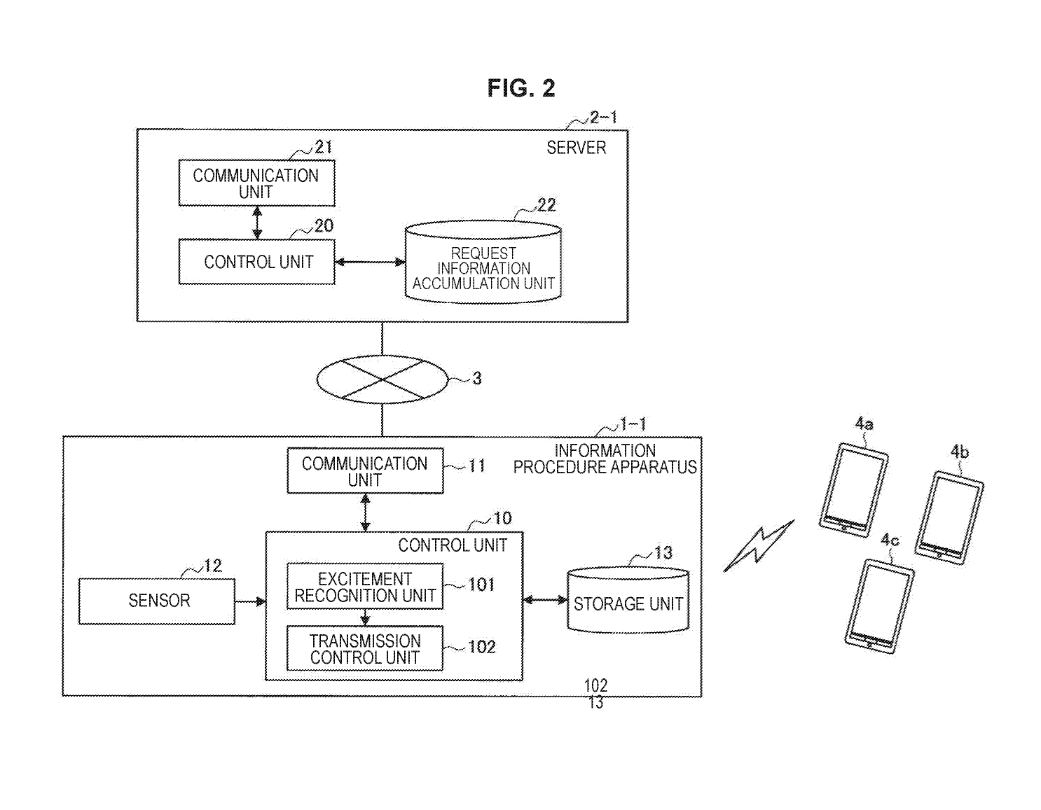

FIG. 2 illustrates the overall configuration of the information processing system according to the first embodiment. As illustrated in FIG. 2, the information processing system according to the present embodiment includes an information processing apparatus 1-1 attached to a target object such as costumed characters, a server 2-1, and communication terminals 4 (4a to 4c) held by a plurality of users existing around the target object.

The information processing apparatus 1-1 is not limited to being attached to a character such as costumed characters, and may be attached to other target objects, for example, a robot or a living thing (clothes that can be worn on a dog, a rabbit, etc.). It can be attached to any object, which attracts people's interest or excites the user approaching or contacting with them.

### (2-1-1. Configuration of Information Processing Apparatus 1-1)

The configuration of the information processing apparatus 1-1 is first described. The information processing apparatus 1-1 has a control unit 10, a communication unit 11, a sensor 12, and a storage unit 13, as illustrated in FIG. 2.

The sensor 12 detects data used to recognize the excitement around a target object, and examples thereof include a pressure sensor, a proximity sensor, an acceleration sensor, a gyro sensor, a camera, a microphone, or the like. The sensor 12 is attached to a character, such as a costumed character, that is, for example, a target object, and detects a fact that surrounding people touch, pat, or hug a character's back, arms, belly, or the like. In addition, the sensor 12 also includes a position information acquisition unit that acquires the current position of a target object.

The control unit 10 functions as an arithmetic processing device and a controller, and controls the overall operation in the information processing apparatus 1-1 in accordance with various programs. The control unit 10 is implemented, in one example, by an electronic circuit such as a central processing unit (CPU) or a microprocessor. In addition, the control unit 10 may include read-only memory (ROM) that stores a program, a parameter for arithmetic operation, or the like to be used and random-access memory (RAM) that temporarily stores parameters or the like that change as appropriate.

Further, the control unit 10 according to the present embodiment also functions as an excitement recognition unit 101 and a transmission control unit 102.

The excitement recognition unit 101 is capable of calculating the degree of excitement of the surrounding people (i.e., the degree of excitement around the character) on the basis of the data detected by the sensor 12. In one example, the excitement recognition unit 101 can calculate the degree (numerical value) indicating the height of excitement on the basis of the number of times or frequency that touching or hugging is occurred and the number, expressions, voice intonation, or the like of surrounding people.

More specifically, in one example, the excitement recognition unit 101 may be a value by dividing the degree of contact with a character (a target object) within a certain period of time by the number of communication terminals of surrounding people within a certain period of time as shown in Formula 1 below.

Degree of excitement=Degree of contact/Number of communication terminals (Formula 1)

In one example, the degree of contact counts the number of times that the value of data detected by the sensor 12 such as a pressure sensor attached to the body of the character exceeds a threshold value. In addition, the number of communication terminals, in one example, counts the number of surrounding communication terminals within a certain range where the signal intensity exceeds a threshold value by detecting a wireless probe signal sent from the communication terminal by the communication unit 11. This makes it possible to recognize that it is excited in a case where the average degree of excitement exceeds a predetermined value even if the degree of excitement per person is not high when getting in contact with many people.

Moreover, the calculation of the degree of excitement is not limited to Formula 1 shown above, and in one example, the degree of contact may be used as the degree of excitement. In addition, in a case of using a camera as the sensor 12, the degree of excitement may be calculated on the basis of a value obtained by further counting the number of smiling people and dividing the degree of contact or the degree of contact by the number of communication terminals and the number of smiling people, in addition to the degree of contact.

The transmission control unit 102 transmits a request by broadcast to the communication terminals held by surrounding people in a case where the excitement recognition unit 101 recognizes that the surroundings are sufficiently excited (e.g., a case where the degree of excitement exceeds a predetermined threshold value). The request to be transmitted is used, in one example, to encourage participation in a particular SNS group.

Further, the transmission control unit 102 transmits the information related to a request (referred to as request information) that is broadcasted to the surroundings to the server 2-1 and stores it in the server 2-1. The request information to be transmitted to the server 2-1 includes, in one example, a request issuance date and time, an issuance location ID, a character ID, a degree of excitement, and an SNS ID. The character ID and the SNS ID are previously registered in, in one example, the storage unit 13. The current position information obtained by a position information acquisition unit (an example of the sensor 12) included in the information processing apparatus 1-1 may be transmitted as the issuance location ID, or the issuance location ID corresponding to the acquired location information may be extracted from an issuance location ID database stored in the storage unit 13.

The communication unit 11 can be connected with an external device by wire or wirelessly to transmit and receive data. In one example, the communication unit 11 transmits or receives data to or from the surrounding communication terminal 4 by Wi-Fi (registered trademark), Bluetooth (registered trademark), short-range wireless communication, or the like. In addition, the communication unit 11 is connected with a network 3 via a wireless local area network (LAN), Wi-Fi (registered trademark), or the like, and transmits or receives data to or from the server 2-1 over the network.

The storage unit 13 is implemented by read-only memory (ROM) that stores a program, a parameter for arithmetic operation, or the like to be used in the processing by the control unit 10 and random-access memory (RAM) that temporarily stores parameters or the like that change as appropriate. The storage unit 13 may store an SNS ID indicating a particular SNS group requested to the user, an ID of a character attached to it, a location ID of the current location, an ID of a performer who operates the character, a history of the calculated degree of excitement, and the like.

### (2-1-2. Configuration of Server 2-1)

The configuration of the server 2-1 is now described. The server 2-1 has a control unit 20, a communication unit 21, and a request information accumulation unit 22, as illustrated in FIG. 2.

The control unit 20 functions as an arithmetic processing device and a controller, and controls the overall operation in the server 2-1 in accordance with various programs. The control unit 20 is implemented, in one example, by an electronic circuit such as a central processing unit (CPU) or a microprocessor. In addition, the control unit 10 may include read-only memory (ROM) that stores a program, a parameter for arithmetic operation, or the like to be used and random-access memory (RAM) that temporarily stores parameters or the like that change as appropriate.

The communication unit 21 can be connected with an external device by wire or wirelessly to transmit and receive data. In one example, the communication unit 21 is connected with the network 3 via a wireless local area network (LAN), Wi-Fi (registered trademark), or the like, and transmits or receives data to or from the information processing apparatus 1-1 attached to the target object.

The request information accumulation unit 22 is a storage unit that accumulates the request information transmitted from the information processing apparatus 1-1. Moreover, the storage unit is implemented by read-only memory (ROM) and random-access memory (RAM) that temporarily stores parameters or the like that change as appropriate.

The accumulated request information includes, in one example, information regarding each location, information regarding each character, information regarding each SNS, and information regarding participants participating in SNS, in addition to information related to a request issued by each information processing apparatus 1-1 (hereinafter also referred to as issuance information). A specific example of contents of data of each pieces of information is described below.

The issuance information includes issuance date and time, an issuance location ID, an issuance character ID, a degree of excitement upon issuance, and an SNS ID indicating a particular SNS group that encourages participation for each issuance ID corresponding to the transmitted request as shown in Table 1 below. Such issuance information is based on the request information transmitted from the information processing apparatus 1-1.

TABLE 1

| Issuance | Issuance date | Issuance | Character | Degree of | |
|---|---|---|---|---|---|
| ID | and time | location ID | ID | excitement | SNS ID |
| R001 | 2016/7/7 | P001 | Y001 | 67 | S001 |
| | 3:55 | | | | |
| R002 | 2016/7/7 | P001 | Y001 | 81 | S001 |
| | 14:32 | | | | |
| R003 | 2016/7/10 | P080 | Y012 | 58 | S002 |
| | 9:54 | | | | |
| . . . | . . . | . . . | . . . | . . . | . . . |

Further, the location information has, for each location ID, a name and address of the location accumulated therein, as shown in Table 2 below.

TABLE 2

| Location ID | Name | Address |
|---|---|---|
| P001 | Tower T | 1-1-1, TT, M-ku, Tokyo |
| . . . | . . . | . . . |

Further, the character information has, for each character ID, a character's name and an ID of a performer who operates the character accumulated therein, as shown in Table 3 below.

TABLE 3

| Character ID | Name | Performer ID |
|---|---|---|
| Y001 | TTT | M906 |
| . . . | . . . | . . . |

Further, the SNS information has, for each SNS ID, a name and a participant ID list accumulated therein, as shown in Table 4 below.

TABLE 4

| SNS ID | Name | Participant ID list |
|---|---|---|
| S001 | Shopping arcade SNS TT | [M001, M017, . . . ] |
| . . . | . . . | . . . |

Further, the participant information has, for each participant ID, a full name, age, or the like accumulated therein, as shown in Table 5 below.

TABLE 5

| Participant ID | Full name | Age |
|---|---|---|
| M001 | AA | 34 |
| . . . | . . . | . . . |

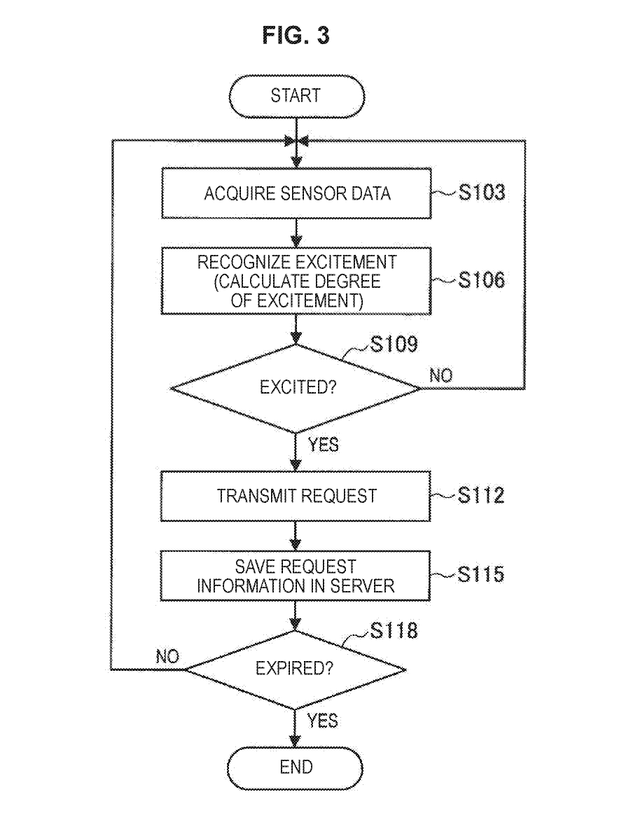

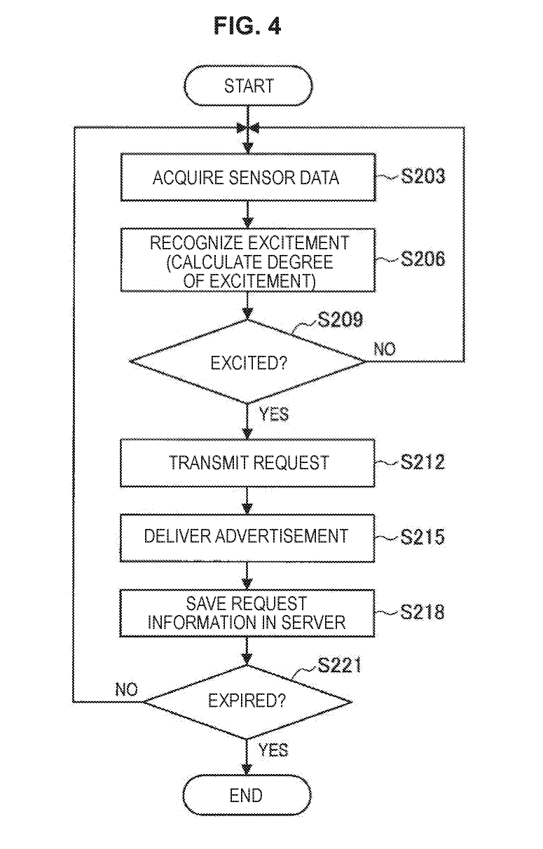

The configuration of the information processing system according to the first embodiment is described in detail above. Subsequently, the operation processing of the information processing system according to the present embodiment is described with reference to FIGS. 3 to 4.

### <2-2. Operation Processing>

FIG. 3 is a flowchart illustrating the operation processing according to the first embodiment. As illustrated in FIG. 3, the information processing apparatus 1-1 first acquires sensor data (sensor data in which contact or the like with the target object is detected) detected by the sensor 12 attached to the target object (step S103).

Then, in the information processing apparatus 1-1, the excitement recognition unit 101 recognizes the excitement (specifically, calculates the degree of excitement) of surrounding people on the basis of the sensor data (step S106).

Then, in case where it can be determined that the degree of excitement exceeds a predetermined threshold and so is exciting (Yes in step S109), the transmission control unit 102 of the information processing apparatus 1-1 broadcasts a request to encourage participation in a particular SNS group to the communication terminals 4 held by the surrounding people (step S112).

Then, the information processing apparatus 1-1 transmits information, which is related to the request broadcasted (issued) to the surroundings, to the server 2-1 and saves it therein (step S115).

The processing of steps S103 to S115 described above is repeated until the event period or the like expires (step S118).

In this way, in the present embodiment, it is possible to perform promotion more effectively by transmitting a predetermined request when the surrounding people are excited.

### <2-3. First Modification>

Subsequently, a first modification of the first embodiment described above is described with reference to FIG. 4. In this modification, in a case where it can be determined that the surroundings are sufficiently excited, the delivery of advertisement information such as coupons to the persons who participated in the relevant SNS group in addition to transmission of the request to encourage participation in a particular SNS group by broadcast makes it possible to perform promotion more effectively.

FIG. 4 is a flowchart illustrating operation processing according to a modification of the first embodiment. First, the processing performed in steps S203 to S212 illustrated in FIG. 4 is similar to the processing shown in steps S103 to S112 of FIG. 3.

Then, in a case where surrounding users participate in a particular SNS group in response to the request, the transmission control unit 102 of the information processing apparatus 1-1 delivers the advertisement information (e.g., advertisement ID) to the participating users (step S215). Specifically, in one example, the information processing apparatus 1-1 broadcasts the advertisement ID including the ID of the participating user (approver) to the surroundings, and so the communication terminal 4 of the user is capable of acquiring (using) the relevant advertise information in a case where the user IDs match. The approver's information may be acquired from, in one example, a server (not shown) of a particular SNS, or may be directly acquired from the communication terminal 4 of the approved user.

Then, the information processing apparatus 1-1 transmits the request information to the server 2-1 and saves it therein (step S218), and then repeats the processing of steps S203 to S218 described above until the event period or the like expires (step S221). Moreover, in this modification, the delivered advertisement ID is also included in the request information transmitted to the server 2-1. Here, Table 6 below shows an example of the issuance information accumulated in the request information accumulation unit 22 of the server 2-1 in the present modification.

TABLE 6

| | Issuance | Issuance | | | | |
|---|---|---|---|---|---|---|
| Issuance | date and | location | | Degree of | | Advertisement |
| ID | time | ID | Character ID | excitement | SNS ID | ID |
| R001 | 2016/7/7 | P001 | Y001 | 67 | S001 | C001 |
| | 13:55 | | | | | |
| R002 | 2016/7/7 | P001 | Y001 | 81 | S001 | C002 |
| | 14:32 | | | | | |
| R003 | 2016/7/10 | P080 | Y012 | 58 | S002 | C003 |
| | 9:54 | | | | | |
| . . . | . . . | . . . | . . . | . . . | . . . | . . . |

In this way, in the present modification, the issuance advertisement ID is also accumulated in association with the issuance ID. In addition, the request information accumulation unit 22 also has advertisement information corresponding to the relevant advertisement ID accumulated therein.

The advertisement information includes the name, start of validity date, end of validity date, and number of times of use of advertisement such as coupons, which are accumulated therein, for each advertisement ID, as shown in Table 7 below.

TABLE 7

| | | | End | |
|---|---|---|---|---|
| Advertisement | | Start of | of validity | Number of |
| ID | Name | validity date | date | times of use |
| C001 | 10% OFF | 2016/7/1 | 2016/9/30 | 38 |
| | for lunch | 0:00 | 23:59 | |
| C002 | Complimentary | . . . | . . . | 53 |
| | Lunch dessert | | | |
| C003 | Prize entry | . . . | . . . | 23 |
| | ticket | | | |
| . . . | . . . | . . . | . . . | . . . |

### <2-4. Second Modification>

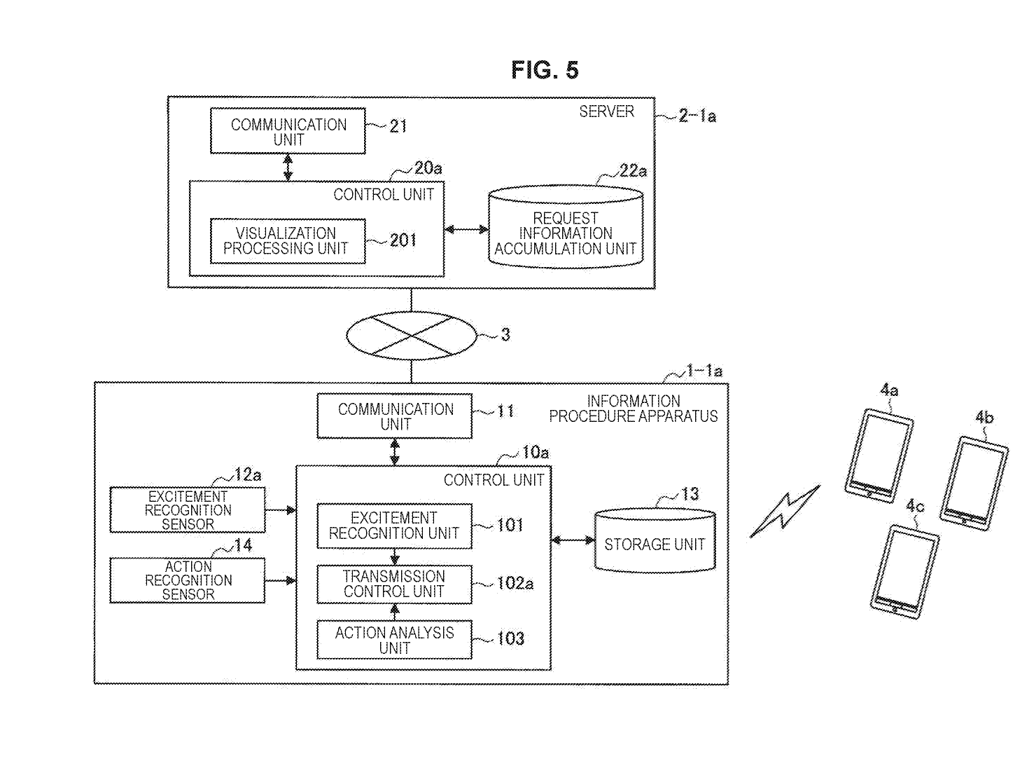

A second modification of the first embodiment is now described with reference to FIGS. 5 to 11. The present modification describes visualization of the effect (e.g., the number of approvals to request for participation in a particular SNS) when a request to encourage participation in a particular SNS group is broadcasted in a case where it can be determined that the surroundings are sufficiently excited. Moreover, in the present modification, transmission of the advertisement information such as coupons to the SNS group participant described in the first modification is also performed, but the present modification is not limited thereto.

### (2-4-1. Configuration)

FIG. 5 illustrates the overall configuration of the information processing system according to the second modification. As illustrated in FIG. 5, the information processing system according to the present embodiment includes an information processing apparatus 1-1a attached to a target object such as costumed characters, a server 2-1a, and communication terminals 4 (4a to 4c) held by a plurality of users existing around the target object.

Configuration of Information Processing Apparatus 1-1a

The information processing apparatus 1-1a includes a control unit 10a, a communication unit 11, an excitement recognition sensor 12a, a storage unit 13, and an action recognition sensor 14.

The excitement recognition sensor 12a detects data used to recognize the excitement around a target object, and examples thereof include a pressure sensor, a proximity sensor, an acceleration sensor, a gyro sensor, a camera, a microphone, or the like, which is similar to the “sensor 12” described with reference to FIG. 2.

The action recognition sensor 14 detects data used to analyze the action of a target object such as costumed characters, and is attached to the target object to detect motion of the target object. Examples thereof include an acceleration sensor attached to the arm of the target object and an acceleration sensor attached to the body. In addition, the action recognition sensor 14 also includes a position information acquisition unit that acquires the current position of the target object.

The control unit 10a functions as the excitement recognition unit 101, a transmission control unit 102a, and an action analysis unit 103. The action analysis unit 103 analyzes the action of the target object on the basis of the sensor data detected by the action recognition sensor 14. In one example, the action analysis unit 103 determines that the action is “wave of arm” in a case where a value of the acceleration sensor attached to the target object's arm is larger than a threshold value and determines that the action is “walking” or “running” in a case where the acceleration sensor attached to the body has a constant period in the direction of gravity, and specifically, determines that the action is “walking” in a case where the value of the acceleration sensor is smaller than the threshold value and determines that the action is “running” in a case where the value of the acceleration sensor is larger than the threshold value.

The excitement recognition unit 101 calculates the degree of excitement of the surrounding people on the basis of the data detected by the sensor 12 as described with reference to FIG. 2.

The transmission control unit 102a transmits a request to the communication terminals held by surrounding people by broadcast in a case where the excitement recognition unit 101 recognizes that the surroundings are sufficiently excited. In addition, the transmission control unit 102a performs advertisement delivery to the user who responds to the request. Furthermore, the transmission control unit 102a regards, as information regarding action that contributed to excitement, the action having the highest frequency among actions of the target object in a certain period before the time when it is recognized that the surroundings are sufficiently excited, and then includes it in the request information and transmits it to the server 2-1a.

Configuration of Server 2-1a

The server 2-1a has a control unit 20a, a communication unit 21, and a request information accumulation unit 22a.

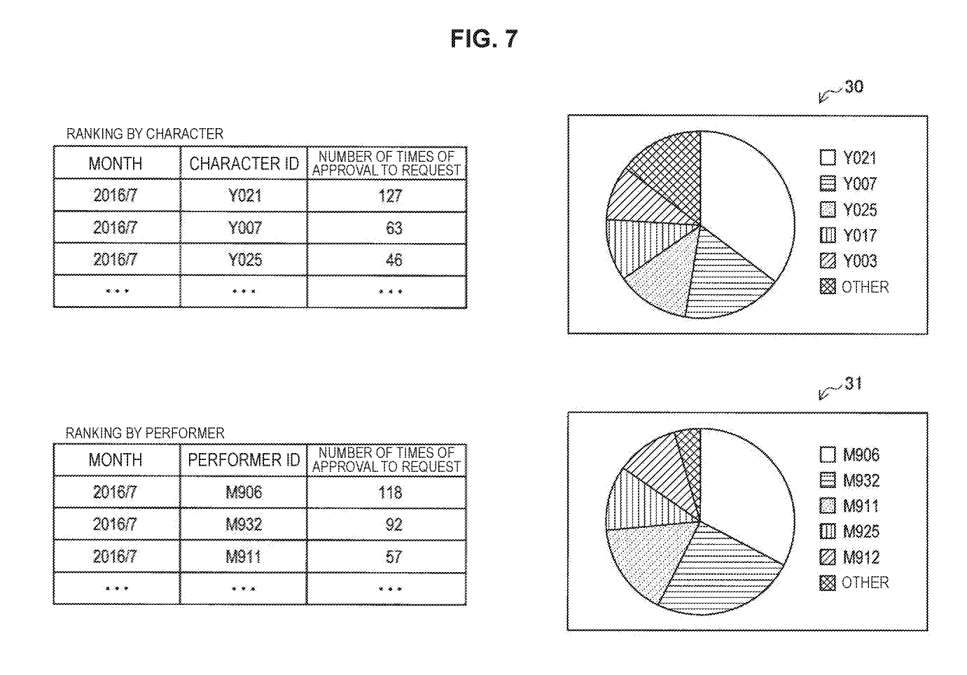

The control unit 20a also functions as a visualization processing unit 201. The visualization processing unit 201 is capable of visualizing a relationship between the character, performer, action of character, degree of excitement, or the like and the number of times of approval to request (or number of times of use of coupons) on the basis of the issuance information or the like accumulated in the request information accumulation unit 22a. A specific example of visualization will be described later with reference to FIGS. 7 to 11. An image generated by the visualization processing can be transmitted to the information processing terminal held by an event organizer, advertiser, or the like and it can be displayed.

The request information accumulation unit 22a includes information related to the request issued (issuance information) by each information processing apparatus 1-1a, information regarding each location, information regarding each character, information regarding each SNS, information regarding participants participating in SNS, and advertisement information, which are accumulated therein. The information regarding each location, the information regarding each character, the information regarding each SNS, the information regarding participants participating in SNS, and the advertisement information are those as shown in Tables 2 to 5 and Table 7 described above.

Further, the information related to the request issued (issuance information) by each information processing apparatus 1-1a includes “action” information of a character at the time of excitement as shown in Table 8 below, in addition to the issuance ID, issuance date and time, issuance location ID, character ID, degree of excitement, SNS ID, and advertisement ID, in addition to the advertisement ID, which are described with reference to Table 6.

TABLE 8

| | Issuance | Issuance | | | | | |
|---|---|---|---|---|---|---|---|
| Issuance | date and | location | Character | Behavior | Degree of | SNS | Advertisement |
| ID | time | ID | ID | information | excitement | ID | ID |
| R001 | 2016/7/7 | P001 | Y001 | Wave of | 67 | S001 | C001 |
| | 13:55 | | | hand | | | |
| R002 | 2016/7/7 | P001 | Y001 | Jumping | 81 | S001 | C002 |
| | 14:32 | | | | | | |
| R003 | 2016/7/10 | P080 | Y012 | Running | 58 | S002 | C003 |
| | 9:54 | | | | | | |
| . . . | . . . | . . . | . . . | . . . | . . . | . . . | . . . |

Such “action” information is an action such as “wave of hand”, “jumping”, or “running” of a character when the surrounding degree of excitement exceeds a threshold value and a request is issued, and it is included in the request information and transmitted from the information processing apparatus 1-1a to the server 2-1a.

### (2-4-2. Operation Processing)

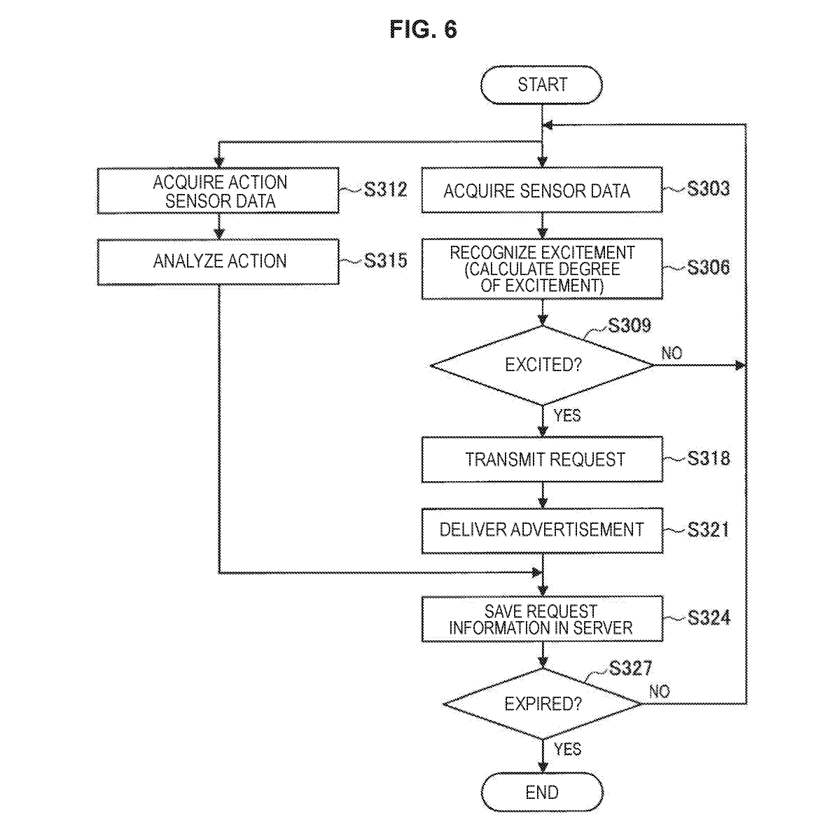

Then, the operation processing of the present modification is described with reference to FIG. 6. FIG. 6 is a flowchart illustrating the operation processing according to the present modification.

First, in steps S303 to S309 illustrated in FIG. 6, the excitement of people around the target object is recognized, which is similar to steps S203 to S209 of FIG. 4.

Further, the acquisition of action sensor data by the action recognition sensor 14 (step S312) and the analysis of action of the target object by the action analysis unit 103 based on the action sensor data (step S315) are continuously performed, in parallel with the excitement recognition.

Then, in a case where the degree of excitement exceeds a predetermined threshold value (Yes in step S309), the transmission control unit 102a of the information processing apparatus 1-1a transmits a predetermined request (here, a request to participate in a particular SNS group) to the communication terminals 4 of the surrounding people (step S318).

Then, the transmission control unit 102a delivers advertisement information (e.g., advertisement ID) to the user who approved the request (here, participated in the particular SNS group in response to the participation request) (step S321).

Subsequently, the transmission control unit 102a transmits the information related to the issued request to the server 2-1a and saves it therein (step S324). Here, the request information to be transmitted to the server 2-1a includes action information (action analysis result analyzed in step S315) indicating an action of the character (target object) upon detecting the excitement, in addition to the issuance ID, the issuance date and time, the issuance location ID, the character ID, the degree of excitement, the SNS ID, and the advertisement ID.

Then, the processing in steps S303 to S324 above is repeated until the event period or the like expires (step S327).

The operation processing according to the present modification is described in detail above. Then, a specific example of visualization of the promotion effect using the request information accumulated in the request information accumulation unit 22a of the server 2-1a is described with reference to FIGS. 7 to 11.

### (2-4-3. Specific Example of Visualization)

The visualization processing unit 201 according to the present modification is capable of visualizing the promotion effect by characters (e.g., the number of times of approval to request) using ranking or graph.

In one example, as shown in the upper part of FIG. 7, the ranking based on the number of times of approval to request by characters (e.g., the number of times of approval of request participation in particular SNS group) and an example of visualization 30 using a pie graph are exemplified. It is found, from the example of visualization 30, that a character Y021 has the largest promotion effect.

Further, as shown in the lower part of FIG. 7, the ranking based on the number of times of approval to request by a performer who operates a character and an example of visualization 31 using the pie graph are exemplified. It is found, from the example of visualization 31, that a performer M906 has the largest performance effect.

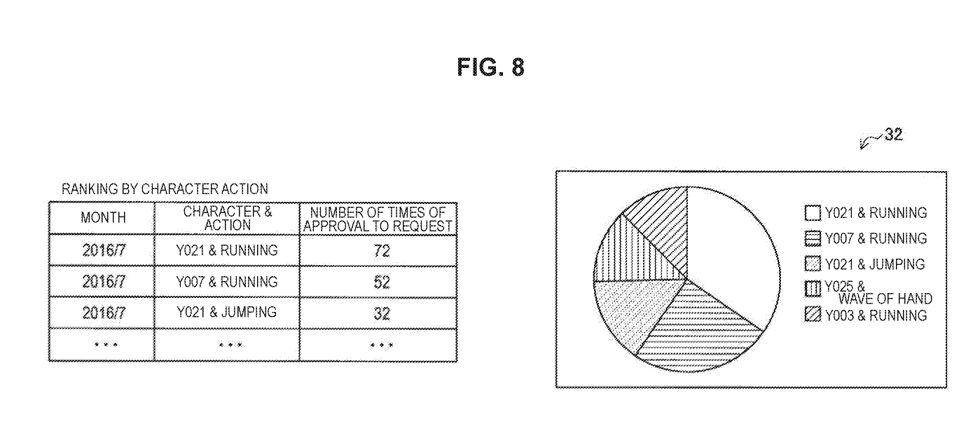

Further, as illustrated in FIG. 8, the ranking based on the number of times of approval to request by character's action and an example of visualization 32 using the pie graph are exemplified. It is found, from the example of visualization 32, that the promotion effect is largest in a case where the action is “running” of the character Y021.

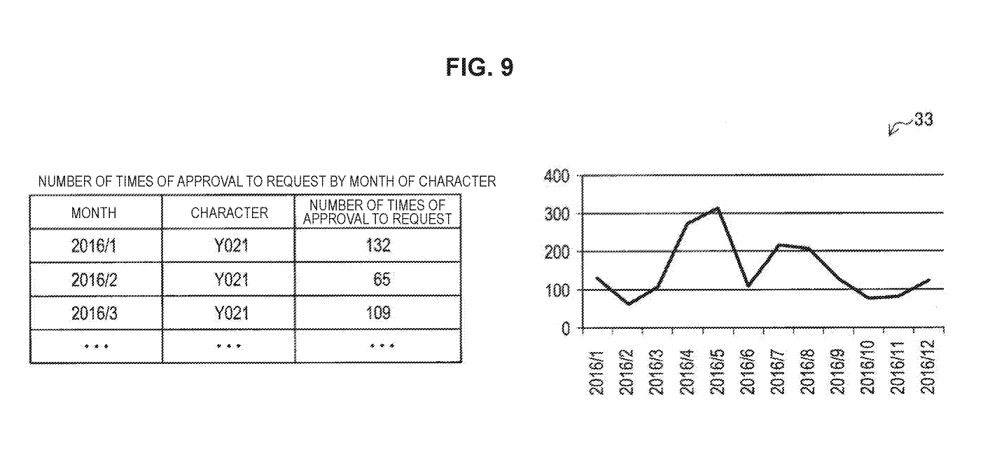

Further, as illustrated in FIG. 9, a table showing the number of times of approval to request of a character by month and an example of visualization 33 using the polygonal line graph are exemplified. It is found, from the example of visualization 33, that the character Y021 has the largest promotion effect in May 2016.

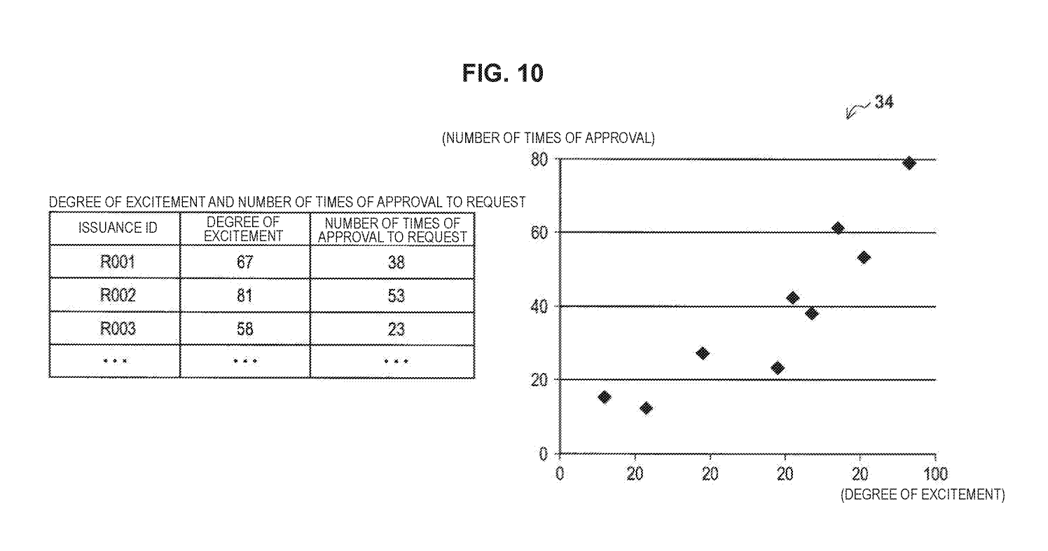

Further, as illustrated in FIG. 10, an example of visualization 34 using a table or graph showing the relationship between the degree of excitement and the number of times of approval to request is exemplified. According to the example of visualization 34, it is possible to grasp the influence of the degree of excitement on the promotion effect.

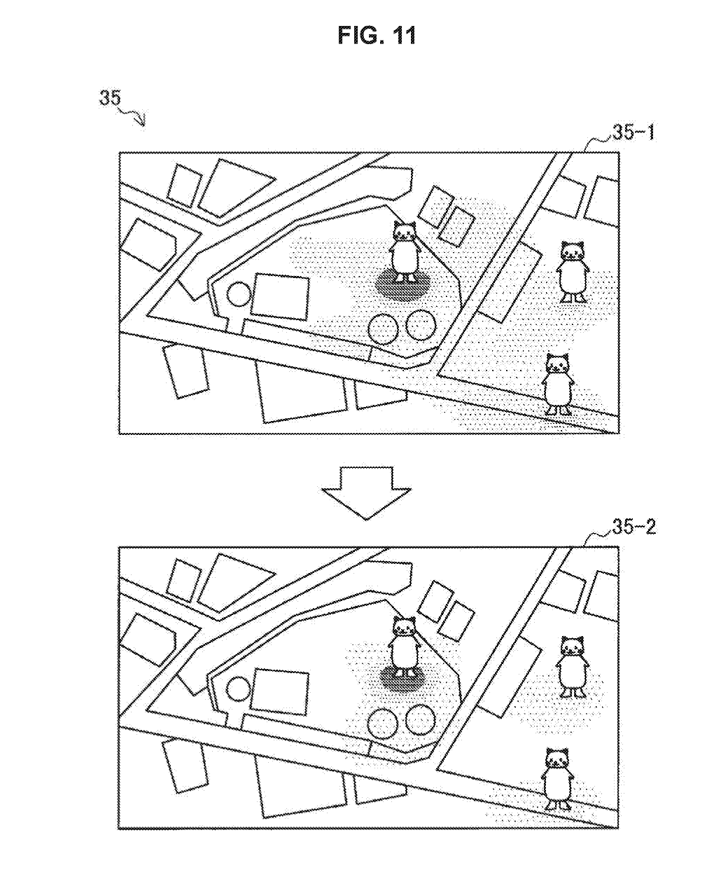

Further, an example of visualization 35 using the issuance location ID associated with the issuance ID, the issued number of coupons (corresponding to the number of times of approval to request in a case of advertisement delivery according to approval to request), and the number of times of use of coupons and indicating by a heat map as illustrated in FIG. 11 is exemplified. The upper part of FIG. 11 shows a heat map image 35-1 that visualizes the number of times of issuance of coupons (number of times of approval to request) at each location. The lower part of FIG. 11 shows a heat map image 35-2 that visualizes the number of coupons used subsequently (number of times of use). This makes it possible to grasp intuitively at which place it is effective to deliver coupons (which location has a greater number of times of use of coupons).

### 3. Second Embodiment

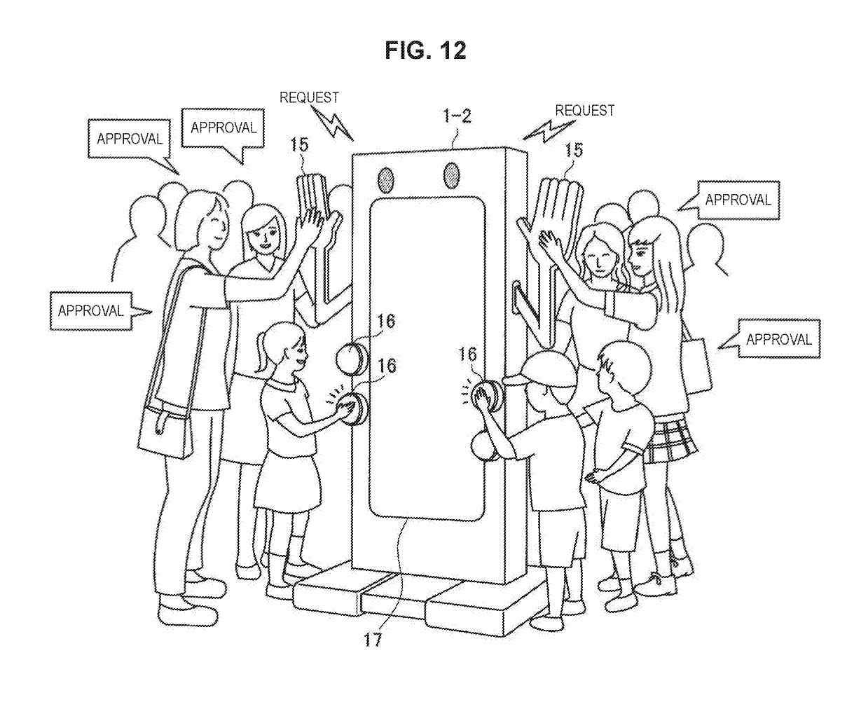

Then, a second embodiment is described with reference to FIGS. 12 to 14. In the first embodiment described above, the case where the information processing apparatus 1-1 is attached to the target object that is a character such as a costumed character is described, but the target object is not limited to the character, and in one example, may be digital signage. A digital signage 1-2 (communication device) according to the present embodiment equipped with functions of the information processing apparatus 1-1 has a configuration for getting familiar to surrounding people or for encouraging proximity or contact and has a sensor that detects the proximity or contact.

Here, an overview of the present embodiment is described with reference to FIG. 12. The digital signage 1-2 is provided with a hand 15 for high touch and a switch device 16 that emits light or makes sound upon being pressed as illustrated in FIG. 12. Moreover, the external configuration of the digital signage 1-2 is not limited to the example illustrated in FIG. 12, and in one example, it may be provided with a tail, an ear, or the like to make the user feel familiar. In addition, it may be provided with a configuration or the like capable of turning a part thereof so that the user can play with it. This makes it possible for the digital signage 1-2 to attract the attention of the surrounding people, encourage proximity or contact, and make the surroundings exciting. In addition, the digital signage 1-2 can be made more enjoyable by providing feedback by a display unit 17 in response to the proximity or contact with the user, for example, by displaying the number of times of high touch or by displaying some indication made when contact with the switch device 16 is detected on the display unit 17.

Then, the digital signage 1-2 detects the excitement of the surrounding people in a similar manner to the first embodiment, and transmits request information such as a request to participate in a particular SNS group to the communication terminal 4 held by the surrounding people when it is determined that it is sufficiently excited, thereby receiving approval from more people.

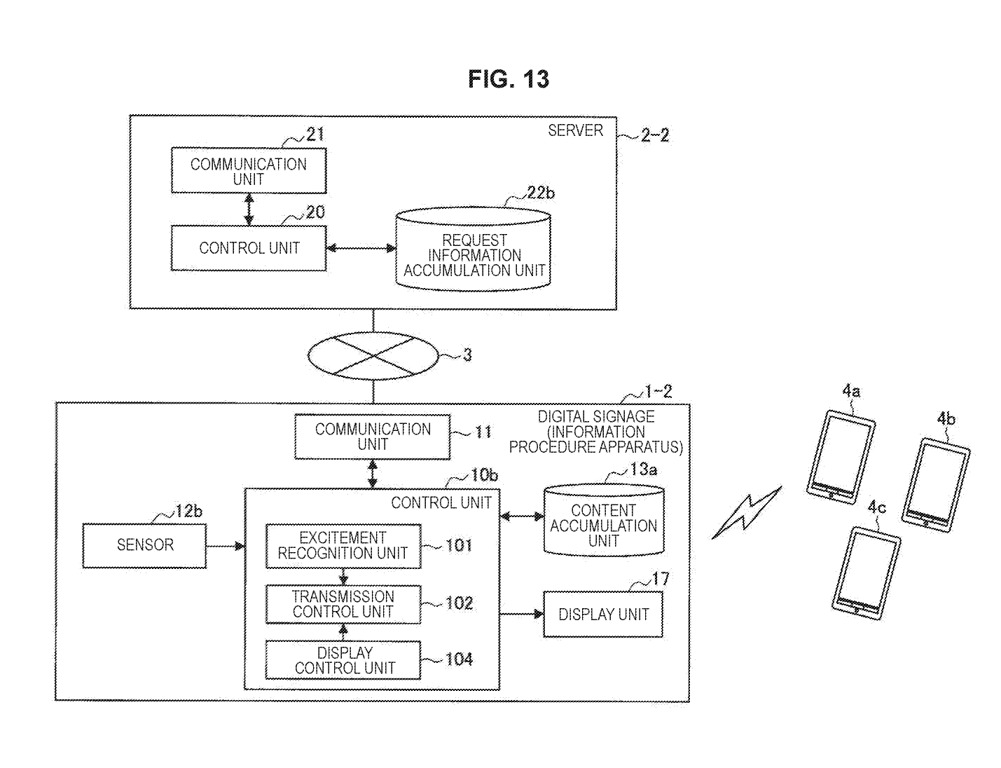

The configuration of the information processing system according to the present embodiment is described below with reference to FIG. 13. Moreover, description of the configuration that is same as the configuration according to the first embodiment described with reference to FIGS. 2 and 5 is omitted.

### <3-1. Configuration>

FIG. 13 is a diagram illustrating the overall configuration of the information processing system according to the second embodiment. As illustrated in FIG. 13, the information processing system according to the present embodiment includes digital signage (information processing apparatus) 1-2, a server 2-2, and communication terminals 4 (4a to 4c) of a plurality of users existing around a target object.

The digital signage 1-2 is not limited to a mounting type like that illustrated in FIG. 12, and may be a mobile type (self-propelled). In addition, here, although digital signage is used as an example of an information processing apparatus having a content output unit, the present embodiment is not limited thereto, and may be a robot or an object having a content output unit. Examples of the content output unit may include a display unit for displaying an image, a projector for projecting an image, a sound output unit for outputting sound, or various actuators for outputting wind, water, smell, vibration, or the like.

### (3-1-1. Configuration of Digital Signage 1-2)

The digital signage 1-2 has a control unit 10b, a communication unit 11, a sensor 12b, a content accumulation unit 13a, and a display unit 17, as illustrated in FIG. 13.

The sensor 12b detects data used to recognize excitement around a target object (the digital signage 1-2), and examples thereof include a pressure sensor, a proximity sensor, a touch sensor, a camera, a microphone, or the like. The sensor 12b is provided in, in one example, the hand 15 or the switch device 16 of the digital signage 1-2 illustrated in FIG. 12, and detects contact with the hand 15, pressing of the switch device 16, or the like.

The control unit 10b functions as an excitement recognition unit 101, a transmission control unit 102, and a display control unit 104. The excitement recognition unit 101 recognizes excitement (calculates the degree of excitement) on the basis of sensor data detected by the sensor 12b, which is similar to the first embodiment.

The transmission control unit 102 is capable of determining that the surroundings are sufficiently excited in a case where the calculated degree of excitement exceeds a predetermined threshold value, so it causes the communication unit 11 to transmit a request to the communication terminals 4 of the surrounding people by broadcast. The request is, in one example, a request for participation in a particular SNS group. In addition, the transmission control unit 102 transmits information related to the request to the server 2-2 and saves it therein as the request information. Here, the request information to be transmitted to the server 2-2 includes information regarding content (content ID) displayed when the excitement exceeds a predetermined threshold value, in addition to the request issuance ID, the issuance date and time, the issuance location ID, the degree of excitement, and the SNS ID described in the first embodiment.

The display control unit 104 controls the display unit 17 to output the content of video or the like (still image or moving image). The content may be accumulated in the content accumulation unit 13a or may be acquired from a predetermined server over a network. In addition, the display control unit 104 outputs information (e.g., a content ID) related to the displayed content to the transmission control unit 102 as necessary. In addition, such content may be interactive content that makes users enjoyable by performing feedback in response to proximity or contact with the user, for example, by displaying the number of times of high touch to the hand 15 or by displaying the number of times the switch device 16 is pressed or some indication depending on this depression, in addition to video.

The display unit 17 displays the content under the control of the display control unit 104. In addition, the display unit 17 is implemented, in one example, by a display device such as a liquid crystal display (LCD), an organic electroluminescence (EL) display, or the like.

### (3-1-2. Configuration of Server 2-2)

The server 2-2 has a control unit 20, a communication unit 21, and a request information accumulation unit 22b, as illustrated in FIG. 13. The control unit 20 and the communication unit 21 are similar to those in the first embodiment, so the description thereof is omitted here.

The request information accumulation unit 22b according to the present embodiment has the content information accumulated therein in addition to issuance information, location information, SNS information, participant information. The location information, the SNS information, and the participant information are those as shown in Tables 2, 4, and 5 above.

The issuance information according to the present embodiment includes an issuance ID, issuance date and time, an issuance location ID, a content ID, a degree of excitement, and an SNS ID, as shown in Table 9 below.

TABLE 9

| Issuance | Issuance date | Issuance | Content | Degree of | |
|---|---|---|---|---|---|
| ID | and time | location ID | ID | excitement | SNS ID |
| R001 | 2016/7/7 | P001 | V013 | 67 | S001 |
| | 13:55 | | | | |
| R002 | 2016/7/7 | P001 | V017 | 81 | S001 |
| | 14:32 | | | | |
| R003 | 2016/7/10 | P080 | V032 | 58 | S002 |
| | 9:54 | | | | |
| . . . | . . . | . . . | . . . | . . . | . . . |

Further, the content information according to the present embodiment includes a content ID, a name, and a type, as shown in Table 10 below.

TABLE 10

| Content ID | Name | Type |
|---|---|---|
| V001 | High touch game | Interactive |
| V002 | Kitten's surprise action | Video |
| V003 | Switch game | Interactive |
| . . . | . . . | . . . |

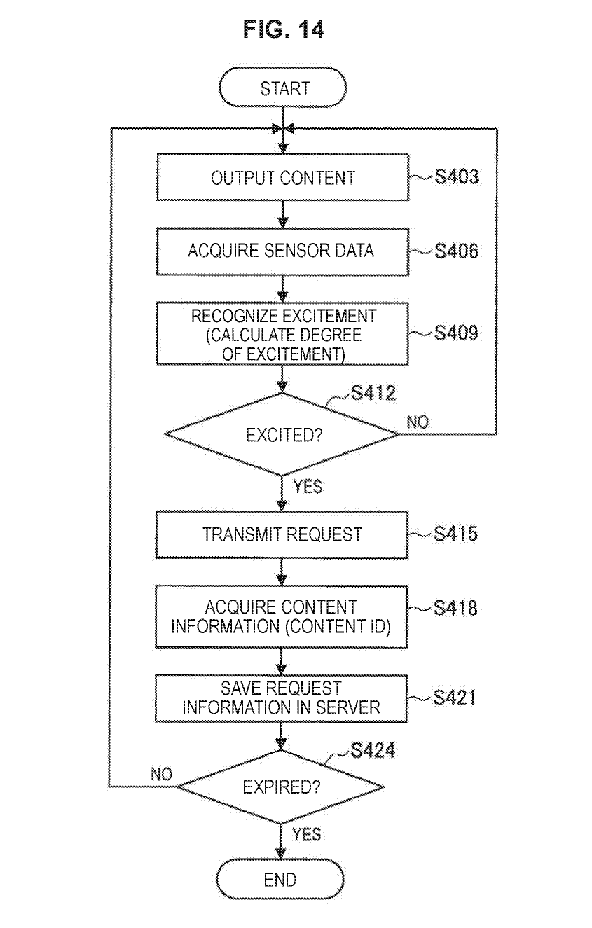

The configuration of the information processing system according to the second embodiment is described in detail above. Subsequently, the operation processing of the information processing system according to the present embodiment is described with reference to FIG. 14.

### <2-2. Operation Processing>

FIG. 14 is a flowchart illustrating the operation processing according to the second embodiment. As illustrated in FIG. 14, first, the display control unit 104 of the digital signage 1-2 controls the display unit 17 to display content such as video (step S403).

Subsequently, the digital signage 1-2 acquires the sensor data (sensor data obtained, for example, by the surrounding people are in contact with the digital signage 1-2) detected by the sensor 12b (step S406)

Then, in the digital signage 1-2, the excitement recognition unit 101 recognizes the excitement (specifically, calculates the degree of excitement) of surrounding people on the basis of the sensor data (step S409).

Then, in case where it can be determined that the degree of excitement exceeds a predetermined threshold and so is exciting (Yes in step S412), the transmission control unit 102 of the digital signage 1-2 broadcasts a request to encourage participation in a particular SNS group to the communication terminals 4 held by the surrounding people (step S415).

Then, the transmission control unit 102 acquires the content information (e.g., the content ID) when the excitement is recognized from the display control unit 104 (step S418).

Then, the digital signage 1-2 transmits information, which is related to the request broadcasted (issued) to the surroundings, to the server 2-1 and saves it therein (step S421). In the present embodiment, the information additionally including the acquired content ID is transmitted to the server 2-1.

The processing of steps S403 to S421 described above is repeated until the event period or the like expires (step S424).

In this way, in the second embodiment, even in the digital signage 1-2 that outputs the content such as video, by recognizing the excitement of the surrounding people and transmitting the request information at appropriate timing, it is possible to increase the number of times of approval to request more effectively.

Further, it is possible for the request information accumulation unit 22b of the server 2-2 to analyze the relationship between the content and the number of times of approval to request by accumulating, as the request information, the content information in association with the issuance ID of the request. In other words, the visualization of a fact that the number of times of approval to request increases when which content is presented using ranking or graph as illustrated in FIGS. 7 to 10 makes it possible to intuitively grasp the influence of the content. In addition, also in the digital signage 1-2, in a case where electronic coupons or the like are distributed to the request approver as in the first modification of the first embodiment, it is possible to similarly perform visualization using the heat map as illustrated in FIG. 11.

### 4. Concluding Remarks

As described above, it is possible for the information processing system according to the embodiment of the present disclosure to transmit the request information to surrounding users at appropriate timing depending on the atmosphere of the surrounding users.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

In one example, it is also possible to create a computer program for causing hardware such as CPU, ROM, and RAM incorporated in the information processing apparatus 1-1, the digital signage 1-2, or the servers 2-1 and 2-2 described above to implement functions of the information processing apparatus 1-1, the digital signage 1-2, or the servers 2-1 and 2-2. In addition, it is possible to provide a computer readable storage medium having the relevant computer program stored therein.

Further, in each of the embodiments described above, the information processing apparatus 1-1 or the digital signage (information processing apparatus) 1-2 recognizes the excitement of the surrounding people, but the present disclosure is not limited thereto, and the server 2 (2-1 or 2-2) may recognize (calculate the degree of excitement) it.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A communication device attachable to a target object, the communication device including:

a detection unit configured to detect contact or proximity of a surrounding user;

a communication unit configured to be capable of transmitting information to a surrounding terminal device; and

a control unit configured to perform control so that request information to be transmitted to the surrounding terminal device depending on an atmosphere of the surrounding user recognized on the basis of detection data detected by the detection unit is transmitted through the communication unit.

(2)

The communication device according to (1),

in which the control unit performs control so that a request for participation in a social media group is broadcasted through the communication unit in a case where an atmosphere of the surrounding user is detected to be excited more than a certain level.

(3)

The communication device according to (1),

in which the control unit

performs control so that a request for participation in a social media group is broadcasted through the communication unit in a case where an atmosphere of the surrounding user is detected to be excited more than a certain level, and

performs control, in a case where information regarding approval to the request for participation is received through the communication unit, so that advertisement information is transmitted through the communication unit to a user issuing the information regarding approval.

(4)

The communication device according to (2) or (3), further including:

a sensor for action recognition configured to sense an action of the target object,

in which the control unit

acquires an action of the target object estimated to be caused by excitement more than the certain level recognized using data sensed by the sensor for action recognition,

performs control so that the request information to be transmitted to the surrounding terminal device is transmitted through the communication unit, and

performs control so that at least one among issuance date and time, issuance position information indicating a position upon issuance, an ID of the target object, a degree of the excitement, an ID of advertisement information, or information regarding the recognized action, which is included in the request information, is transmitted to a server device through the communication unit.

(5)

The communication device according to any one of (2) to (4),

in which the control unit determines that excitement is more than a certain level in a case where a value obtained by dividing a degree of contact or proximity by the number of the surrounding terminal devices exceeds a predetermined threshold value on the basis of the detection data detected by the detection unit.

(6)

The communication device according to any one of (2) to (4), further including:

a position information detection unit configured to be capable of detecting current position information,

in which the control unit

performs control so that the request information to be transmitted to the surrounding terminal device depending on an atmosphere of the surrounding user is transmitted through the communication unit, and

performs control so that at least one among issuance date and time, issuance position information indicating a position upon issuance, an ID of the target object, or a degree of the excitement, which is included in the request information, is transmitted to a server device through the communication unit.

(7)

The communication device according to any one of (1) to (6),

in which the control unit, in a case where the target object is a display device capable of displaying content,

performs control so that a request for participation in a social media group is broadcasted through the communication unit in a case where an atmosphere of the surrounding user is detected to be excited more than a certain level, and

performs control so that information related to content displayed on the display device is transmitted to a server device through the communication unit.

(8)

A server device including:

a communication unit configured to receive information from a communication device that is attached to a target object and capable of transmitting request information to a surrounding terminal device depending on an atmosphere estimated via contact or proximity of a surrounding user of the target object; and

a control unit configured to generate visualization information on the basis of at least one piece of information among issuance date and time, issuance position information indicating a position of the communication device upon issuance, an ID of the target object, a degree of excitement of the surrounding user, or content information included in the request information, which is received by the communication unit, when the communication device transmits the request information to the surrounding terminal device.

(9)

The server device according to (8),

in which the control unit generates visualization information indicating an advertisement effect of advertisement information on the basis of at least one piece of information among issuance date and time, issuance position information indicating a position of the communication device upon issuance, an ID of the target object, a degree of excitement of the surrounding user, an ID of the advertisement information, or an action of the target object included in the request information, which is received by the communication unit, when the communication device transmits a request for participation in a social media group as the request information and the advertisement information.

(10)

A recording medium having a program recorded thereon, the program causing a computer to function as:

a detection unit configured to detect contact or proximity of a surrounding user;

a communication unit configured to be capable of transmitting information to a surrounding terminal device; and

a control unit configured to perform control so that request information to be transmitted to the surrounding terminal device depending on an atmosphere of the surrounding user recognized on the basis of detection data detected by the detection unit is transmitted through the communication unit.

(11)

A control method including:

receiving, by a processor, information through a communication unit from a communication device that is attached to a target object and capable of transmitting request information to a surrounding terminal device depending on an atmosphere estimated via contact or proximity of a surrounding user of the target object; and

generating, by the processor, visualization information on the basis of at least one piece of information among issuance date and time, issuance position information indicating a position of the communication device upon issuance, an ID of the target object, a degree of excitement of the surrounding user, or content information included in the request information, which is received by the communication unit, when the communication device transmits the request information to the surrounding terminal device.

### REFERENCE SIGNS LIST

1-1 information processing apparatus (communication device)
1-2 digital signage (communication device)
2-1, 2-2 server
3 network
4 communication terminal
10 control unit
101 recognition unit
102, 102a transmission control unit
103 action analysis unit
104 display control unit
11 communication unit
12 sensor
12a excitement recognition sensor
13 storage unit
14 action recognition sensor
17 display unit
20 control unit
201 visualization processing unit
21 communication unit
22, 22a, 22b request information accumulation unit

1. A communication device attachable to a target object, the communication device comprising:
a detection unit configured to detect contact or proximity of a surrounding user;
a communication unit configured to be capable of transmitting information to a surrounding terminal device; and
a control unit configured to perform control so that request information to be transmitted to the surrounding terminal device depending on an atmosphere of the surrounding user recognized on a basis of detection data detected by the detection unit is transmitted through the communication unit.

2. The communication device according to claim 1,
wherein the control unit performs control so that a request for participation in a social media group is broadcasted through the communication unit in a case where an atmosphere of the surrounding user is detected to be excited more than a certain level.

3. The communication device according to claim 1,
wherein the control unit
performs control so that a request for participation in a social media group is broadcasted through the communication unit in a case where an atmosphere of the surrounding user is detected to be excited more than a certain level, and
performs control, in a case where information regarding approval to the request for participation is received through the communication unit, so that advertisement information is transmitted through the communication unit to a user issuing the information regarding approval.

4. The communication device according to claim 2, further comprising:
a sensor for action recognition configured to sense an action of the target object,
wherein the control unit
acquires an action of the target object estimated to be caused by excitement more than the certain level recognized using data sensed by the sensor for action recognition,
performs control so that the request information to be transmitted to the surrounding terminal device is transmitted through the communication unit, and
performs control so that at least one among issuance date and time, issuance position information indicating a position upon issuance, an ID of the target object, a degree of the excitement, an ID of advertisement information, or information regarding the recognized action, which is included in the request information, is transmitted to a server device through the communication unit.

5. The communication device according to claim 2,
wherein the control unit determines that excitement is more than a certain level in a case where a value obtained by dividing a degree of contact or proximity by a number of the surrounding terminal devices exceeds a predetermined threshold value on the basis of the detection data detected by the detection unit.

6. The communication device according to claim 2, further comprising:
a position information detection unit configured to be capable of detecting current position information,
wherein the control unit
performs control so that the request information to be transmitted to the surrounding terminal device depending on an atmosphere of the surrounding user is transmitted through the communication unit, and
performs control so that at least one among issuance date and time, issuance position information indicating a position upon issuance, an ID of the target object, or a degree of the excitement, which is included in the request information, is transmitted to a server device through the communication unit.

7. The communication device according to claim 1,
wherein the control unit, in a case where the target object is a display device capable of displaying content,
performs control so that a request for participation in a social media group is broadcasted through the communication unit in a case where an atmosphere of the surrounding user is detected to be excited more than a certain level, and
performs control so that information related to content displayed on the display device is transmitted to a server device through the communication unit.

8. A server device comprising:
a communication unit configured to receive information from a communication device that is attached to a target object and capable of transmitting request information to a surrounding terminal device depending on an atmosphere estimated via contact or proximity of a surrounding user of the target object; and
a control unit configured to generate visualization information on a basis of at least one piece of information among issuance date and time, issuance position information indicating a position of the communication device upon issuance, an ID of the target object, a degree of excitement of the surrounding user, or content information included in the request information, which is received by the communication unit, when the communication device transmits the request information to the surrounding terminal device.

9. The server device according to claim 8,
wherein the control unit generates visualization information indicating an advertisement effect of advertisement information on a basis of at least one piece of information among issuance date and time, issuance position information indicating a position of the communication device upon issuance, an ID of the target object, a degree of excitement of the surrounding user, an ID of the advertisement information, or an action of the target object included in the request information, which is received by the communication unit, when the communication device transmits a request for participation in a social media group as the request information and the advertisement information.

10. A recording medium having a program recorded thereon, the program causing a computer to function as:
a detection unit configured to detect contact or proximity of a surrounding user;
a communication unit configured to be capable of transmitting information to a surrounding terminal device; and
a control unit configured to perform control so that request information to be transmitted to the surrounding terminal device depending on an atmosphere of the surrounding user recognized on a basis of detection data detected by the detection unit is transmitted through the communication unit.

11. A control method comprising:
receiving, by a processor, information through a communication unit from a communication device that is attached to a target object and capable of transmitting request information to a surrounding terminal device depending on an atmosphere estimated via contact or proximity of a surrounding user of the target object; and
generating, by the processor, visualization information on a basis of at least one piece of information among issuance date and time, issuance position information indicating a position of the communication device upon issuance, an ID of the target object, a degree of excitement of the surrounding user, or content information included in the request information, which is received by the communication unit, when the communication device transmits the request information to the surrounding terminal device.
